(19) United States
(12) Patent Application Publication
(10) Pub. No.: US 2026/0297312 A1
(43) Pub. Date: Oct. 1, 2026

(54) RESIN COMPOSITION, METHOD FOR PRODUCING RESIN COMPOSITION, AND INJECTION MOLDED ARTICLE

(71) Applicants: HONDA MOTOR CO., LTD., Tokyo (JP); SUMITOMO CHEMICAL COMPANY, LIMITED, Tokyo (JP)

(72) Inventors: Ayano IKEDA, Tokyo (JP); Sawa HAGIHARA, Saitama (JP); Ken NAKANE, Tokyo (JP); Hiroshi FUKURODA, Chiba (JP); Mitsuyoshi SHIMANO, Chiba (JP); Koji KAMEO, Chiba (JP)

(21) Appl. No.: 19/479,638

(22) PCT Filed: Apr. 9, 2024
(86) PCT No.: PCT/JP2024/014335

§ 371 Date: Oct. 28, 2025

(30) Foreign Application Priority Data
May 15, 2023 (JP) 2023-080116

(51) Int. Cl. C08L 23/12; C08J 3/22; C08L 23/16

(52) U.S. Cl. CPC C08L 23/12; C08J 3/226; C08L 23/16; C08J 2323/12; C08J 2323/16; C08J 2423/08; C08L 2205/025; C08L 2205/03; C08L 2205/035; C08L 2207/20; C08L 2310/00

(57) ABSTRACT

A resin composition according to the present disclosure includes: a component (A): a crushed material of waste car bumpers including 1 mass % or more and less than 30 mass % of a xylene-insoluble matter; a component (B): peeled powder of coated film of waste car bumpers including 30 mass % or more and less than 50 mass % of a xylene-insoluble matter; and a component (C): a propylene-based polymer, in which a content of the component (A) is 15 mass % or more and 35 mass % or less, a content of the component (B) is 15 mass % or more and 35 mass % or less, and a content of the component (C) is 30 mass % or more and 70 mass % or less, based on a total mass of the resin composition.

### CROSS-REFERENCE TO RELATED APPLICATION

This application claims priority to Japanese Patent Application No. 2023-080116, the disclosure of which is incorporated herein by reference in its entirety.

### FIELD

The present disclosure relates to a resin composition, a method for producing the resin composition, and an injection molded article including the resin composition.

### BACKGROUND

Employed conventionally as plastic recycling has typically been thermal recycling in which heat in combusting waste plastics is recovered for reuse. In May 2019, however, the Ministry of the Environment of Japan formulated the “Resource Circulation Strategy for Plastics”, in which effective use of 100% of used plastics by, for example, reducing and recycling by 2035 was clearly stated. In such social situations, there is a growing demand for material recycling in which waste plastics are reused as raw materials for plastic products.

With good molding processability and excellent rigidity, heat resistance, and the like, polypropylene has been widely used for, e.g., car parts (for example, exterior parts such as bumpers, interior parts such as door trims or instrument panels) and housings of electrical home appliances. Therefore, polypropylene molded bodies used in the market are recovered for reuse as raw materials for plastic products.

Polypropylene molded bodies are also required to be excellent in design. For example, Patent Literature 1 discloses that a molded article of a resin composition obtained by mixing a polypropylene resin and aluminum powder has metallic appearance.

### CITATION LIST

### Patent Literature

Patent Literature 1: JP 2006-009034 A

### SUMMARY

### Technical Problem

The present disclosure has been conceived in view of such circumstances, and it is an object to provide a resin composition capable of obtaining a molded article relatively excellent in design by increasing the number of externally visible coating films while reusing polypropylene; a method for producing the resin composition; and an injection molded article including the resin composition.

### Solution to Problem

A resin composition according to the present disclosure includes: a component (A): a crushed material of waste car bumpers including 1 mass % or more and less than 30 mass % of a xylene-insoluble matter; a component (B): peeled powder of coated film of waste car bumpers including 30 mass % or more and less than 50 mass % of a xylene-insoluble matter; and a component (C): a propylene-based polymer, in which a content of the component (A) is 15 mass % or more and 35 mass % or less, a content of the component (B) is 15 mass % or more and 35 mass % or less, and a content of the component (C) is 30 mass % or more and 70 mass % or less, based on a total mass of the resin composition.

A method for producing a resin composition according to the present disclosure includes a step of melt kneading a mixture without allowing the mixture to pass through a screen mesh, the mixture including: a component (A): a crushed material of waste car bumpers including 1 mass % or more and less than 30 mass % of a xylene-insoluble matter; a component (B): peeled powder of coated film of waste car bumpers including 30 mass % or more and less than 50 mass % of a xylene-insoluble matter; and a component (C): a propylene-based polymer, in which a content of the component (A) is 15 mass % or more and 35 mass % or less, a content of the component (B) is 15 mass % or more and 35 mass % or less, a content of the component (C) is 30 mass % or more and 70 mass % or less, based on a total mass of the mixture.

An injection molded article according to the present disclosure includes the resin composition.

### DESCRIPTION OF EMBODIMENTS

A description will be hereinafter given on an embodiment of the present disclosure, but the present disclosure is not limited to the following embodiments.

### [Resin Composition]

A resin composition according to this embodiment includes a component (A): a crushed material of waste car bumpers including 1 mass % or more and less than 30 mass % of a xylene-insoluble matter, a component (B): peeled powder of coated film of waste car bumpers including 30 mass % or more and less than 50 mass % of a xylene-insoluble matter, and a component (C): a propylene-based polymer. Further, the resin composition preferably includes a component (D): an ethylene-α-olefin copolymer.

### <Component (A)>

The crushed material of waste car bumpers as the component (A) is obtained by crushing the waste car bumpers recovered from the market, or the waste car bumpers recovered in processes due to, for example, defective coating and thus failing to be made into products. The waste car bumpers have coated films.

The component (A) includes 1 mass % or more and less than 30 mass %, preferably includes 1 mass % or more and 25 mass % or less, of the xylene-insoluble matter based on the total mass of the component (A). The content of the xylene-insoluble matter can be calculated by weighing a residue obtained by Soxhlet extraction.

The crushed material as the component (A) can have a maximum dimension of, for example, 20 mm or less.

The component (A) can include the propylene-based polymer to be discussed as the following component (C). The content of the propylene-based polymer is preferably 40 mass % or more, more preferably 50 mass % or more, based on the total mass of the component (A). The content of the propylene-based polymer is preferably 99 mass % or less, more preferably 95 mass % or less, based on the total mass of the component (A).

The component (A) can include the ethylene-α-olefin copolymer to be discussed as the following component (D). The content of the ethylene-α-olefin copolymer is preferably 1 mass % or more, more preferably 5 mass % or more, based on the total mass of the component (A). The content of the ethylene-α-olefin copolymer is preferably 50 mass % or less, more preferably 30 mass % or less, based on the total mass of the component (A).

The component (A) can include a filler to be described later. The content of the filler is preferably 1 mass % or more, more preferably 5 mass % or more, based on the total mass of the component (A). The content of the filler is preferably 50 mass % or less, more preferably 30 mass % or less, based on the total mass of the component (A).

The content of the component (A) is 15 mass % or more and 35 mass % or less based on the total mass of the resin composition. The content of the component (A) is preferably 20 mass % or more, more preferably 25 mass % or more, based on the total mass of the resin composition. The content of the component (A) is preferably 30 mass % or less, more preferably 28 mass % or less, based on the total mass of the resin composition.

The component (A) has a melt flow rate (MFR) of preferably 1 g/10 minutes or more and 100 g/10 minutes or less, more preferably 12 g/10 minutes or more and 70 g/10 minutes or less, further preferably 15 g/10 minutes or more and 50 g/10 minutes or less. In terms of achieving an improved molding processability of the obtained resin composition, the MFR of the component (A) is preferably 10 g/10 minutes or more. In terms of achieving an increased impact strength of the obtained molded article, the MFR of the component (A) is preferably 100 g/10 minutes or less. The MFR of the component (A) is measured by the method A at a temperature of 230° C. and a load of 2.16 kg according to the method specified in JIS K 7210-1995.

The component (A) can include an additive such as a neutralizer, an antioxidant, an ultraviolet absorber, a nucleating agent, a lubricant, an antistatic agent, an anti-blocking agent, or a colorant (e.g., an inorganic pigment, an organic pigment, a pigment dispersant), depending on the application. The recovery process of the component (A) is not particularly limited, and a known method can be used therefor.

### <Component (B)>

The peeled powder of coated film of waste car bumpers as the component (B) is obtained by peeling coated films from waste car bumpers recovered from the market, or the waste car bumpers recovered in processes due to, for example, defective coating and thus failing to be made into products. The method for peeling the component (B) is not particularly limited, but a known method can be used therefor.

The component (B) includes 30 mass % or more and less than 50 mass %, preferably 35 mass % or more and 45 mass % or less, of the xylene-insoluble matter based on the total mass of the component (B). The content of the xylene-insoluble matter can be calculated by weighing a residue obtained by Soxhlet extraction.

In one aspect, the component (B) includes titanium oxide. The content of the titanium oxide is preferably 0.05 mass % or more, more preferably 0.1 mass % or more, based on the total mass of the component (B). The content of the titanium oxide is preferably 5 mass % or less, more preferably 4.8 mass % or less, based on the total mass of the component (B). In one aspect, the content of the titanium oxide is 0.05 mass % or more and 5 mass % or less based on the total mass of the component (B).

In one aspect, the component (B) includes aluminum metal. The content of the aluminum metal is preferably 0.01 mass % or more, more preferably 0.02 mass % or more, based on the total mass of the component (B). The content of the aluminum metal is preferably 1 mass % or less, more preferably 0.8 mass % or less, based on the total mass of the component (B). In one aspect, the content of the aluminum metal is 0.01 mass % or more and 1 mass % or less based on the total mass of the component (B).

In one aspect, the component (B) includes talc. The content of the talc is preferably 5 mass % or more, more preferably 10 mass % or more, based on the total mass of the component (B). The content of the talc is preferably 20 mass % or less, more preferably 15 mass % or less, based on the total mass of the component (B). In one aspect, the content of the talc is 5 mass % or more and 20 mass % or less based on the total mass of the component (B).

The content of the component (B) is 15 mass % or more and 35 mass % or less based on the total mass of the resin composition. The content of the component (B) is preferably 20 mass % or more, more preferably 25 mass % or more, based on the total mass of the resin composition. The content of the component (B) is preferably 30 mass % or less, more preferably 28 mass % or less, based on the total mass of the resin composition.

### <Component (C)>

The propylene-based polymer as the component (C) is a polymer including 50 mass % or more of a monomer unit derived from propylene. Examples of the propylene-based polymer include a propylene homopolymer, a random copolymer of propylene and a non-propylene monomer, and a heterophasic propylene polymer material. The resin composition according to this embodiment can include only one kind of propylene-based polymer, or can include two or more kinds thereof.

In terms of achieving good molding processability of the resin composition, the component (C) has a melt flow rate (MFR) of preferably 0.1 g/10 minutes or more, more preferably 1 g/10 minutes or more and 300 g/10 minutes or less, further preferably 5 g/10 minutes or more and 300 g/10 minutes or less. The MFR of the component (C) is measured by the method A at a temperature of 230° C. and a load of 2.16 kg according to the method specified in JIS K 7210-1995.

The content of the component (C) is 30 mass % or more and 70 mass % or less based on the total mass of the resin composition. The content of the component (C) is preferably 35 mass % or more, more preferably 38 mass % or more, based on the total mass of the resin composition. The content of the component (C) is preferably 60 mass % or less, more preferably 50 mass % or less, based on the total mass of the resin composition.

### (Propylene Homopolymer)

In terms of achieving an improved fluidity in melting the resin composition and an improved toughness of the molded product, the propylene homopolymer has an intrinsic viscosity ([η]) of preferably 0.10 dL/g or more and 4.00 dL/g or less, more preferably 0.50 dL/g or more and 3.00 dL/g or less, further preferably 0.70 dL/g or more and 2.00 dL/g or less.

The intrinsic viscosity (unit: dL/g) herein is a value measured at a temperature of 135° C. by the method below using tetralin as a solvent.

Reduced viscosities are measured for three points respectively having concentrations of 0.1 g/dL, 0.2 g/dL, and 0.5 g/dL, using an Ubbelohde type viscometer. The intrinsic viscosity is obtained by the extrapolation method in which the reduced viscosities are plotted relative to the concentrations and the concentrations are extrapolated to zero. The method for calculating the intrinsic viscosity by the extrapolation method is described on, for example, page 491 of “Koubunshi Youeki: Koubunshi Jikken-gaku 11 (lit.: “Polymer Solution: Polymer Experimental Studies 11”)” (published by KYORITSU SHUPPAN CO., LTD. in 1982).

The propylene homopolymer can be produced through, for example, a polymerization step in which propylene is polymerized using a polymerization catalyst.

Examples of the polymerization catalyst include: a Ziegler type catalyst; a Ziegler-Natta type catalyst; a catalyst including alkylaluminoxane and a transition metal compound of group 4 in the periodic table having a cyclopentadienyl ring; a catalyst including a transition metal compound of group 4 in the periodic table having a cyclopentadienyl ring, a compound that reacts with the transition metal compound to form an ionic complex, and an organoaluminum compound; and a catalyst obtained by supporting a catalyst component (e.g., a transition metal compound of group 4 in the periodic table having a cyclopentadienyl ring, a compound that forms an ionic complex, an organoaluminum compound) on inorganic particles (e.g., silica, clay mineral) for modification.

Examples of the polymerization catalyst include those catalysts disclosed in JP S61-218606 A, JP H5-194685 A, JP H7-216017 A, JP H9-316147 A, JP H10-212319 A, JP 2004-182981 A, JP 2010-168545 A, and JP 2011-246699 A.

A polymer obtained by prepolymerizing propylene in the presence of the polymerization catalyst can be used as the polymerization catalyst.

Examples of the polymerization method include bulk polymerization, solution polymerization, and gas phase polymerization. The bulk polymerization herein refers to a method for polymerization using, as a medium, an olefin being in a liquid form at a polymerization temperature. The solution polymerization refers to a method for polymerization in an inert hydrocarbon solvent such as propane, butane, isobutane, pentane, hexane, heptane, or octane. The gas phase polymerization refers to a method for polymerizing a gaseous monomer in the gaseous monomer as a medium.

Examples of a polymerization system include a batch system, a continuous system, and a combination thereof. The polymerization system can be a multistage system in which a plurality of polymerization reaction vessels are connected in series.

In terms of being industrially and economically excellent, a preferable polymerization method is a continuous gas phase polymerization method, or a bulk-gas phase polymerization method in which the bulk polymerization method and the gas phase polymerization method are continuously performed.

Various conditions in the polymerization step (polymerization conditions such as a polymerization temperature, a polymerization pressure, a monomer concentration, a catalyst input amount, a period of polymerization) can be appropriately determined depending on the molecular structure of the target polymer.

In the method for producing the propylene homopolymer, other steps can be performed before or after the polymerization step. For example, after the polymerization step, the polymer can be dried, as necessary, at a temperature equal to or lower than the temperature at which the polymer is molten to remove, e.g., a residual solvent included in the polymer or an ultralow molecular weight oligomer being a by-product formed during production. Examples of the drying method include the methods described in, e.g., JP S55-075410 A and JP 2565753 B.

### (Random Copolymer of Propylene and Non-Propylene Monomer)

The random copolymer of propylene and the non-propylene monomer includes a monomer unit derived from propylene and a monomer unit derived from the non-propylene monomer. The random copolymer preferably includes 0.01 mass % or more and 20 mass % or less of the monomer unit derived from the non-propylene monomer based on the total mass of the copolymer.

Examples of the non-propylene monomer include ethylene and an α-olefin having 4 to 12 carbon atoms. The α-olefin herein is an aliphatic unsaturated hydrocarbon having a carbon-carbon unsaturated double bond at the α position. Examples of the α-olefin having 4 to 12 carbon atoms include 1-butene, 1-pentene, 1-hexene, 1-heptene, 1-octene, 1-nonene, 1-decene, 1-dodecene, 4-methyl-1-pentene, and 4-methyl-1-hexene.

The non-propylene monomer is preferably at least one selected from the group consisting of ethylene and an α-olefin having 4 to 10 carbon atoms, more preferably at least one selected from the group consisting of ethylene, 1-butene, 1-hexene, and 1-octene, further preferably at least one selected from the group consisting of ethylene and 1-butene.

Examples of the random copolymer of propylene and the non-propylene monomer include a propylene-ethylene random copolymer, a propylene-1-butene random copolymer, a propylene-1-hexene random copolymer, a propylene-1-octene random copolymer, a propylene-ethylene-1-butene random copolymer, a propylene-ethylene-1-hexene random copolymer, and a propylene-ethylene-1-octene random copolymer.

In terms of achieving an improved fluidity in melting the propylene resin composition, the random copolymer of propylene and the non-propylene monomer has an intrinsic viscosity ([η]) of preferably 0.10 dL/g or more and 4.00 dL/g or less, more preferably 0.50 dL/g or more and 3.00 dL/g or less, further preferably 0.70 dL/g or more and 2.00 dL/g or less.

The random copolymer of propylene and the non-propylene monomer can be produced by, for example, polymerizing propylene and the non-propylene monomer according to the polymerization catalyst, the polymerization method, the polymerization system, and the polymerization conditions that can be used in producing the above propylene homopolymer.

### (Heterophasic Propylene Polymer Material)

The heterophasic propylene polymer material is a mixture including: a polymer I including 80 mass % or more of the monomer unit derived from propylene (where the total mass of the polymer I is 100 mass %); and a polymer II including the monomer unit derived from propylene and a monomer unit derived from at least one α-olefin selected from the group consisting of ethylene and an α-olefin having 4 to 12 carbon atoms.

The heterophasic propylene polymer material can be produced, for example, by carrying out a first polymerization step of polymerizing the polymer I, and a second polymerization step of polymerizing the polymer II. These polymerization steps can be carried out according to the polymerization catalyst, the polymerization method, the polymerization system, and the polymerization conditions that can be used in producing the above propylene homopolymer.

In the heterophasic propylene polymer material, a total of the polymer I and the polymer II included in the heterophasic propylene polymer material can be 100 mass % relative to the total mass of the heterophasic propylene polymer material.

As described above, the polymer I includes 80 mass % or more of the monomer unit derived from propylene (where the total mass of the polymer I is 100 mass %). The polymer I can be, for example, the propylene homopolymer, or can include the monomer unit derived from the non-propylene monomer. When the polymer I includes the monomer unit derived from the non-propylene monomer, the content thereof can be, for example, 0.01 mass % or more and less than 20 mass % based on the total mass of the polymer I.

Examples of the non-propylene monomer include ethylene and an α-olefin having 4 or more carbon atoms. Examples of the α-olefin having 4 or more carbon atoms include 1-butene, 1-pentene, 1-hexene, 1-heptene, 1-octene, 1-nonene, 1-decene, 1-dodecene, 4-methyl-1-pentene, and 4-methyl-1-hexene.

The non-propylene monomer is preferably at least one selected from the group consisting of ethylene and an α-olefin having 4 to 10 carbon atoms, more preferably at least one selected from the group consisting of ethylene, 1-butene, 1-hexene, and 1-octene, further preferably at least one selected from the group consisting of ethylene and 1-butene.

Examples of the polymer I including the monomer unit derived from the non-propylene monomer include a propylene-ethylene copolymer, a propylene-1-butene copolymer, a propylene-1-hexene copolymer, a propylene-1-octene copolymer, a propylene-ethylene-1-butene copolymer, a propylene-ethylene-1-hexene copolymer, and a propylene-ethylene-1-octene copolymer.

In terms of achieving good dimension stability of the molded article, the polymer I is preferably a propylene homopolymer, a propylene-ethylene copolymer, a propylene-1-butene copolymer, or a propylene-ethylene-1-butene copolymer, more preferably a propylene homopolymer.

The content of the polymer I is preferably 50 mass % or more and 99 mass % or less, more preferably 60 mass % or more and 95 mass % or less, based on the total mass of the heterophasic propylene polymer material.

As described above, the polymer II includes the monomer unit derived from at least one α-olefin selected from the group consisting of ethylene and an α-olefin having 4 to 12 carbon atoms, and the monomer unit derived from propylene. Examples of the α-olefin having 4 to 12 carbon atoms include 1-butene, 1-pentene, 1-hexene, 1-heptene, 1-octene, 1-nonene, 1-decene, 1-dodecene, 4-methyl-1-pentene, and 4-methyl-1-hexene.

The polymer II preferably includes 30 mass % or more of the monomer unit derived from at least one α-olefin selected from the group consisting of ethylene and the α-olefin having 4 to 12 carbon atoms, and includes the monomer unit derived from propylene (where the total mass of the polymer II is 100 mass %).

In the polymer II, the content of the monomer unit derived from at least one α-olefin selected from the group consisting of ethylene and the α-olefin having 4 to 12 carbon atoms can be 30 mass % or more and 70 mass % or less, can be 35 mass % or more and 60 mass % or less (where the total mass of the polymer II is 100 mass %).

In the polymer II, the at least one α-olefin selected from the group consisting of ethylene and the α-olefin having 4 to 12 carbon atoms is preferably at least one selected from the group consisting of ethylene and an α-olefin having 4 to 10 carbon atoms, more preferably at least one selected from the group consisting of ethylene, 1-butene, 1-hexene, 1-octene, and 1-decene, further preferably at least one selected from the group consisting of ethylene and 1-butene.

Examples of the polymer II include a propylene-ethylene copolymer, a propylene-ethylene-1-butene copolymer, a propylene-ethylene-1-hexene copolymer, a propylene-ethylene-1-octene copolymer, a propylene-ethylene-1-decene copolymer, a propylene-1-butene copolymer, a propylene-1-hexene copolymer, a propylene-1-octene copolymer, and a propylene-1-decene copolymer. Among these, the polymer II is preferably a propylene-ethylene copolymer, a propylene-1-butene copolymer, or a propylene-ethylene-1-butene copolymer, more preferably a propylene-ethylene copolymer.

The content of the polymer II is preferably 1 mass % or more and 50 mass % or less, more preferably 5 mass % or more and 40 mass % or less, based on the total mass of the heterophasic propylene polymer material.

In the heterophasic propylene polymer material, the content of the monomer unit derived from the at least one α-olefin selected from the group consisting of ethylene and the α-olefin having 4 to 12 carbon atoms can be 0.3 mass % or more and 35 mass % or less, can be 0.7 mass % or more and 24 mass % or less (where the total mass of the heterophasic propylene polymer material is 100 mass %).

Examples of the heterophasic propylene polymer material include a (propylene)-(propylene-ethylene) polymer material, a (propylene)-(propylene-ethylene-1-butene) polymer material, a (propylene)-(propylene-ethylene-1-hexene) polymer material, a (propylene)-(propylene-ethylene-1-octene) polymer material, a (propylene)-(propylene-1-butene) polymer material, a (propylene)-(propylene-1-hexene) polymer material, a (propylene)-(propylene-1-octene) polymer material, a (propylene)-(propylene-1-decene) polymer material, a (propylene-ethylene)-(propylene-ethylene) polymer material, a (propylene-ethylene)-(propylene-ethylene-1-butene) polymer material, a (propylene-ethylene)-(propylene-ethylene-1-hexene) polymer material, a (propylene-ethylene)-(propylene-ethylene-1-octene) polymer material, a (propylene-ethylene)-(propylene-ethylene-1-decene) polymer material, a (propylene-ethylene)-(propylene-1-butene) polymer material, a (propylene-ethylene)-(propylene-1-hexene) polymer material, a (propylene-ethylene)-(propylene-1-octene) polymer material, a (propylene-ethylene)-(propylene-1-decene) polymer material, a (propylene-1-butene)-(propylene-ethylene) polymer material, a (propylene-1-butene)-(propylene-ethylene-1-butene) polymer material, a (propylene-1-butene)-(propylene-ethylene-1-hexene) polymer material, a (propylene-1-butene)-(propylene-ethylene-1-octene) polymer material, a (propylene-1-butene)-(propylene-ethylene-1-decene) polymer material, a (propylene-1-butene)-(propylene-1-butene) polymer material, a (propylene-1-butene)-(propylene-1-hexene) polymer material, a (propylene-1-butene)-(propylene-1-octene) polymer material, a (propylene-1-butene)-(propylene-1-decene) polymer material, a (propylene-1-hexene)-(propylene-1-hexene) polymer material, a (propylene-1-hexene)-(propylene-1-octene) polymer material, a (propylene-1-hexene)-(propylene-1-decene) polymer material, a (propylene-1-octene)-(propylene-1-octene) polymer material, and a (propylene-1-octene)-(propylene-1-decene) polymer material.

Herein, the description “(propylene)-(propylene-ethylene) polymer material” refers to a “heterophasic propylene polymer material in which the polymer I is a propylene homopolymer and the polymer II is a propylene-ethylene copolymer”. The same applies to other similar expressions.

The heterophasic propylene polymer material is preferably a (propylene)-(propylene-ethylene) polymer material, a (propylene)-(propylene-ethylene-1-butene) polymer material, a (propylene-ethylene)-(propylene-ethylene) polymer material, a (propylene-ethylene)-(propylene-ethylene-1-butene) polymer material, or a (propylene-1-butene)-(propylene-1-butene) polymer material, more preferably a (propylene)-(propylene-ethylene) polymer material.

The intrinsic viscosity of the polymer I ([η] I) is preferably 0.10 dL/g or more and 4.00 dL/g or less, more preferably 0.50 dL/g or more and 3.00 dL/g or less, further preferably 0.70 dL/g or more and 2.00 dL/g or less.

The intrinsic viscosity of the polymer II ([η] II) is preferably 1.00 dL/g or more and 10.00 dL/g or less, more preferably 2.00 dL/g or more and 10.00 dL/g or less, further preferably 2.00 dL/g or more and 9.00 dL/g or less.

A ratio of the intrinsic viscosity of the polymer II ([η] II) to the intrinsic viscosity of the polymer I ([η] I) ([η] II/[η] I) is preferably 1 or more and 20 or less, more preferably 1 or more and 10 or less.

Examples of the method for measuring the intrinsic viscosity of the polymer I ([η] I) include the method in which the polymerized polymer I is extracted from a reactor for polymerizing the polymer I to measure the intrinsic viscosity of the polymer.

The intrinsic viscosity of the polymer II ([η] II) can be calculated by a formula (i) below using, for example, the intrinsic viscosity of the heterophasic propylene polymer material ([η] Total), the intrinsic viscosity of the polymer I ([η] I), and the contents of the polymer II and the polymer I.

$$[ η ] II = ( [ η ] Total - [ η ] I \times XI ) / XII \qquad ( i )$$

[η] Total: Intrinsic viscosity of heterophasic propylene polymer material (dL/g)
[η] I: Intrinsic viscosity of polymer I (dL/g)
XI: Ratio of mass of polymer I to total mass of heterophasic propylene polymer material (mass of polymer I/mass of heterophasic propylene polymer material)
XII: Ratio of mass of polymer II to total mass of heterophasic propylene polymer material (mass of polymer II/mass of heterophasic propylene polymer material)
XI and XII can be obtained from the mass balance at the time of polymerization.
XII can be calculated using a formula below, by measuring the heat of fusion of the polymer I and the heat of fusion of the heterophasic propylene polymer material:

$$XII = 1 - ( Δ Hf ) T / ( Δ Hf ) P$$

(ΔHf) T: Heat of fusion of heterophasic propylene polymer material (J/g)
(ΔHf) P: Heat of fusion of polymer I (J/g)

### <Component (D)>

The resin composition according to this embodiment can include an ethylene-α-olefin copolymer being the component (D). The ethylene-α-olefin copolymer can be an ethylene-α-olefin random copolymer. The ethylene-α-olefin copolymer is a copolymer including the monomer unit derived from ethylene and the monomer unit derived from an α-olefin having 4 or more carbon atoms, and refers to a copolymer not substantially including the monomer unit derived from propylene.

In the ethylene-α-olefin copolymer as the component (D), the total of the content of the monomer unit derived from ethylene and the content of the monomer unit derived from the α-olefin having 4 or more carbon atoms can be 100 mass %.

Examples of the α-olefin having 4 or more carbon atoms include an α-olefin having 4 to 12 carbon atoms. Examples of the α-olefin having 4 to 12 carbon atoms include 1-butene, 1-pentene, 1-hexene, 4-methyl-1-pentene, 1-octene, and 1-decene. The α-olefin having 4 to 12 carbon atoms is preferably 1-butene, 1-hexene, or 1-octene. The α-olefin having 4 to 12 carbon atoms can also be an α-olefin having a cyclic structure, such as vinylcyclopropane or vinylcyclobutane.

Examples of the ethylene-α-olefin copolymer include an ethylene-1-butene copolymer, an ethylene-1-hexene copolymer, an ethylene-1-octene copolymer, an ethylene-1-decene copolymer, an ethylene-(3-methyl-1-butene) copolymer, and a copolymer of ethylene and an α-olefin having a cyclic structure.

In the ethylene-α-olefin copolymer, the content of the monomer unit derived from the α-olefin having 4 or more carbon atoms is preferably 1 mass % or more and 49 mass % or less, more preferably 5 mass % or more and 49 mass % or less, further preferably 24 mass % or more and 49 mass % or less, based on the total mass of the ethylene-α-olefin copolymer.

In terms of achieving an improved impact resistance of the molded article, the component (D) has a density of preferably 0.85 g/cm³ or more and 0.89 g/cm³ or less, more preferably 0.85 g/cm³ or more and 0.88 g/cm³ or less, further preferably 0.85 g/cm³ or more and 0.87 g/cm³ or less.

The melt flow rate (MFR) of the component (D) is preferably 0.1 g/10 minutes or more and 80 g/10 minutes or less. The MFR of the ethylene-α-olefin copolymer is measured by the method A at a temperature of 190° C. and a load of 2.16 kg according to the method specified in JIS K 7210-1995.

The content of the component (D) is preferably 5 mass % or more, more preferably 7 mass % or more, based on the total mass of the resin composition. The content of the component (D) is preferably 15 mass % or less, more preferably 12 mass % or less, based on the total mass of the resin composition. In one aspect, the content of the component (D) is 5 mass % or more and 15 mass % or less based on the total mass of the resin composition.

The ethylene-α-olefin copolymer being the component (D) can be produced by polymerizing ethylene and the α-olefin having 4 or more carbon atoms using a polymerization catalyst.

Examples of the polymerization catalyst include a homogeneous catalyst represented by a metallocene catalyst, and a Ziegler-Natta-type catalyst.

Examples of the homogeneous catalyst include: a catalyst including alkylaluminoxane and a transition metal compound of group 4 in the periodic table having a cyclopentadienyl ring; a catalyst including a transition metal compound of group 4 in the periodic table having a cyclopentadienyl ring, a compound that reacts with the transition metal compound to form an ionic complex, and an organoaluminum compound; and a catalyst obtained by carrying a catalyst component (e.g., a transition metal compound of group 4 in the periodic table having a cyclopentadienyl ring, a compound that forms an ionic complex, an organoaluminum compound) on inorganic particles (e.g., silica, clay mineral) for modification.

Examples of the Ziegler-Natta-type catalyst include a catalyst obtained by combining a titanium-containing solid transition metal component and an organometallic component.

A commercially available ethylene-α-olefin copolymer can be used. Examples of the commercially available ethylene-α-olefin copolymer include ENGAGE (registered trademark) manufactured by Dow Chemical Japan Ltd., TAFMER (registered trademark) manufactured by Mitsui Chemicals, Inc., NEO-ZEX (registered trademark) and ULTZEX (registered trademark) manufactured by Prime Polymer Co., Ltd., and EXCELLEN FX (registered trademark), SUMIKATHENE (registered trademark), and ESPRENE SPO (registered trademark) manufactured by Sumitomo Chemical Co., Ltd.

### <Filler>

The resin composition according to this embodiment can include a filler. Examples of the filler include an inorganic filler and an organic filler. The resin composition can include only one kind of filler, or can include two or more kinds thereof.

Examples of the inorganic filler include glass, silicate minerals, alumina, silica, silicon dioxide, titanium oxide, iron oxide, aluminum oxide, magnesium oxide, antimony oxide, barium ferrite, strontium ferrite, beryllium oxide, magnesium hydroxide, aluminum hydroxide, basic magnesium carbonate, calcium carbonate, magnesium carbonate, carbonate minerals, calcium sulfate, magnesium sulfate, basic magnesium sulfate, calcium sulfite, carbon black, and cadmium sulfide.

Examples of the organic filler include a polyester, an aromatic polyamide, cellulose and vinylon.

The shape of the filler can be a plate shape, a needle shape, or a fibrous shape.

In terms of achieving an improved rigidity, impact resistance, and dimensional stability of the molded article, the filler is preferably an inorganic filler, more preferably talc as a silicate mineral having a plate shape.

### <Resin Composition>

The shape of the resin composition according to this embodiment is not particularly limited, and can be, for example, a strand shape, a sheet shape, a flat plate shape, or a pellet shape. The resin composition having a pellet shape can be produced by, for example, forming a resin composition having a strand shape, followed by cutting the strand into pieces each having an appropriate length.

In terms of achieving an improved molding processability of the resin composition and an improved production stability when producing a molded article, the resin composition before being molded into a molded article preferably has a pellet shape with a length of about 1 to 50 mm.

The resin composition according to this embodiment can include other components in addition to those above. Examples of the other components include a neutralizer, an antioxidant, an ultraviolet absorber, a nucleating agent, a lubricant, an antistatic agent, an anti-blocking agent, a processing aid, an organic peroxide, and a colorant (e.g., an inorganic pigment, an organic pigment, a pigment dispersant).

The melt flow rate (MFR) of the resin composition according to this embodiment is preferably 1 g/10 minutes or more and 100 g/10 minutes or less, more preferably 12 g/10 minutes or more and 70 g/10 minutes or less, further preferably 15 g/10 minutes or more and 40 g/10 minutes or less. In terms of achieving an improved molding processability, the MFR of the resin composition is preferably 10 g/10 minutes or more. In terms of achieving an improved impact strength of a resulting molded article, the MFR of the resin composition is preferably 100 g/10 minutes or less. The MFR of the resin composition is measured by the method A at a temperature of 230° C. and a load of 2.16 kg according to the method specified in JIS K 7210-1995.

The density of the resin composition according to this embodiment is preferably 1.30 g/cm³ or less, more preferably 1.20 g/cm³ or less, further preferably 1.10 g/cm³ or less. The density of the resin composition is preferably 0.80 g/cm³ or more, more preferably 0.85 g/cm³ or more, further preferably 0.90 g/cm³ or more. The density is measured by the underwater substitution method, which is the method A described in JIS K 7112.

### [Method for Producing Resin Composition]

A method for producing a resin composition according to this embodiment includes a step of melt kneading a mixture without allowing the mixture to pass through a screen mesh, the mixture including: a component (A): a crushed material of waste car bumpers including 1 mass % or more and less than 30 mass % of a xylene-insoluble matter; a component (B): peeled powder of coated film of waste car bumpers including 30 mass % or more and less than 50 mass % of a xylene-insoluble matter; and a component (C): a propylene-based polymer, in which a content of the component (A) is 15 mass % or more and 35 mass % or less, a content of the component (B) is 15 mass % or more and 35 mass % or less, and a content of the component (C) is 30 mass % or more and 70 mass % or less, based on a total mass of the mixture.

The mixture includes the component (A), the component (B), and the component (C). The mixture can further include an ethylene-α-olefin copolymer as the above component (D), a filler, and other components.

In the melt kneading step, the temperature at the time of melt kneading can be 180° C. or more, can be 180° C. or more and 300° C. or less, can be 180° C. or more and 250° C. or less.

Used for the melt kneading can be, for example, a Banbury mixer, a single-screw extruder, or a twin-screw codirectional extruder.

The order of kneading the material components included in the mixture is not particularly limited. For example, the kneading can be carried out such that all components are kneaded collectively, or that some components are kneaded first, followed by kneading the resulting kneaded product with other components.

### [Injection Molded Article]

An injection molded article according to this embodiment includes the resin composition. That is, the resin composition can be used as a material for being molded into the injection molded article.

The injection molded article can be manufactured by an injection molding method. Examples of the injection molding method include a general injection molding method, an injection foam molding method, a supercritical injection foam molding method, an ultra-high-speed injection molding method, an injection compression molding method, a gas-assisted injection molding method, a sandwich molding method, a sandwich foam molding method, and an insert/outsert molding method. The shape of the injection molded article is not particularly limited.

The injection molded article can be used, for example, for car material applications, home appliance material applications, and container applications, and can preferably be used for interior and exterior car parts applications. Examples of the interior and exterior car parts include door trims, pillars, instrument panels, and bumpers.

The present disclosure includes the following aspects:
[1] A resin composition including:
   a component (A): a crushed material of waste car bumpers including 1 mass % or more and less than 30 mass % of a xylene-insoluble matter;
   a component (B): peeled powder of coated film of waste car bumpers including 30 mass % or more and less than 50 mass % of a xylene-insoluble matter; and
   a component (C): a propylene-based polymer, in which
   a content of the component (A) is 15 mass % or more and 35 mass % or less, a content of the component (B) is 15 mass % or more and 35 mass % or less, and a content of the component (C) is 30 mass % or more and 70 mass % or less, based on a total mass of the resin composition.
[2] The resin composition according to [1], further including a component (D): an ethylene-α-olefin copolymer, in which
   a content of the component (D) is 5 mass % or more and 15 mass % or less based on the total mass of the resin composition.
[3] The resin composition according to [1] or [2], in which the component (B) includes titanium oxide, and
   a content of the titanium oxide is 0.05 mass % or more and 5 mass % or less based on a total mass of the component (B).
[4] The resin composition according to any one of [1] to [3], in which the component (B) includes aluminum metal, and
   a content of the aluminum metal is 0.01 mass % or more and 1 mass % or less based on a total mass of the component (B).
[5] The resin composition according to any one of [1] to [4], in which the component (B) includes talc, and
   a content of the talc is 5 mass % or more and 20 mass % or less based on a total mass of the component (B).
[6] A method for producing a resin composition including a step of melt kneading a mixture without allowing the mixture to pass through a screen mesh, the mixture including: a component (A): a crushed material of waste car bumpers including 1 mass % or more and less than 30 mass % of a xylene-insoluble matter; a component (B): peeled powder of coated film of waste car bumpers including 30 mass % or more and less than 50 mass % of a xylene-insoluble matter; and a component (C): a propylene-based polymer, in which
   a content of the component (A) is 15 mass % or more and 35 mass % or less, a content of the component (B) is 15 mass % or more and 35 mass % or less, and a content of the component (C) is 30 mass % or more and 70 mass % or less, based on a total mass of the mixture.
[7] An injection molded article including the resin composition according to any one of [1] to [5].

The resin composition, the method for producing the resin composition, and the injection molded article according to the present disclosure are not limited to the configurations of the aforementioned embodiment. The resin composition, the method for producing the resin composition, and the injection molded article according to the present disclosure are not limited by the aforementioned operations and effects, either. Various modifications can be made to the resin composition, the method for producing the resin composition, and the injection molded article according to the present disclosure without departing from the gist of the present disclosure.

### EXAMPLES

Hereinafter, the present disclosure will be described in more details by way of Examples. However, the present disclosure is not limited to these Examples.

### <Materials>

The materials below were used in Examples and Comparative Examples.

### Component (A): Crushed Material of Waste Car Bumpers

Prepared as the component (A) was the following (A-1), i.e., the crushed material of waste car bumpers with coated films attached that had been recovered from the market.

(A-1) Crushed Material of Waste Car Bumpers with Coated Films Attached that are Recovered from the Market
MFR (at a temperature of 230° C. and a load of 2.16 kg): 42 g/10 minutes
Content of xylene-insoluble matter: 23.2 mass %

### Component (B): Peeled Powder of Coated Film of Waste Car Bumpers

Prepared as the component (B) was peeled powder of coated film of waste car bumpers recovered from the market as in (B-1) to (B-4) below.

(B-1) Peeled Powder of Coated Film of Waste Car Bumpers Recovered from the Market
Number of steps of peeling coating film: 2
Content of xylene-insoluble matter: 42.8 mass %
   (B-2) Peeled Powder of Coated Film of Waste Car Bumpers Recovered from the Market
Number of steps of peeling coating film: 3
Content of xylene-insoluble matter: 41.7 mass %
   (B-3) Peeled Powder of Coated Film of Waste Car Bumpers Recovered from the Market
Number of steps of separating coating film: 4
Content of xylene-insoluble matter: 40.7 mass %
   (B-4) Peeled Powder of Coated Film of Waste Car Bumpers Recovered from the Market
Number of steps of peeling coating film: 6
Content of xylene-insoluble matter: 36.5 mass %

### (Content of Xylene-Insoluble Matter)

4 g of the component (A) and the component (B) were weighed and refluxed with boiling xylene for five hours using cylindrical filter paper and a Soxhlet extraction tube. The Soxhlet extraction residue, which remained on the cylindrical filter paper after the reflux, was allowed to vacuum-dry, and the resulting residue was weighed to obtain the content of xylene-insoluble matter. The xylene-insoluble matter of the component (A) and the component (B) is thought to be composed mainly of a coating film and talc.

### Component (C): Propylene-Based Polymer

Prepared as the component (C) were the propylene-based polymers of (C-1) and (C-2) below.

### (C-1) Heterophasic Propylene Polymer Material

MFR (at a temperature of 230° C. and a load of 2.16 kg): 27 g/10 minutes
Propylene homopolymer (polymer I): 80 mass %
Ethylene-propylene random copolymer (polymer II): 20 mass %

The mass ratio XII of the polymer II to the total mass of the heterophasic propylene polymer material was calculated from the following equation using the crystal fusion heat of the polymer I and the crystal fusion heat of the entire heterophasic propylene polymer material.

$$XII = 1 - ( Δ Hf ) T / ( Δ Hf ) P$$

(ΔHf) T: Heat of fusion of the entire heterophasic propylene polymer material (polymer I and polymer II) (unit: cal/g)
(ΔHf) P: Heat of fusion of polymer I (unit: cal/g)

### (C-2) Ethylene-Propylene Random Copolymer

MFR (at a temperature of 230° C. and a load of 2.16 kg): 25 g/10 minutes
Ethylene content: 2.5 mass %

### Component (D): Ethylene-α-Olefin Copolymer

Prepared as the component (D) was an ethylene-α-olefin random copolymer of (D-1) below.

### (D-1) Ethylene-1-Octene Random Copolymer

MFR (at a temperature of 190° C. and a load of 2.16 kg): 1.0 g/10 minutes
Density: 0.858 g/cm³

### <Production of Resin Compositions>

### Examples 1 to 9 and Comparative Examples 1 to 4

Using a single-screw extruder V40-NSIII (cylinder inner diameter of 40.0 mm, screw outer diameter of 39.5 mm, L/D=28) manufactured by TANABE PLASTICS MACHINERY CO., LTD., the composition in Table 1 was melt kneaded at a cylinder temperature of 230° C., a screw rotation speed of 40 rpm, and a discharge rate of 7 kg/hr, without using a screen mesh but using a breaker plate in a cylindrical shape (outer diameter: 55.0 mm, inner diameter: 40.0 mm, length: 20.0 mm), to obtain a resin composition in a pellet form.

### Comparative Example 5

The melt kneading was performed in the same manner as described above, but no strand was successfully drawn due to foaming from the die head, failing to obtain a resin composition in a pellet form.

### Comparative Example 6

Using a single-screw extruder V40-NSIII (cylinder inner diameter of 40.0 mm, screw outer diameter of 39.5 mm, L/D=28) manufactured by TANABE PLASTICS MACHINERY CO., LTD., the composition in Table 1 was melt kneaded at a cylinder temperature of 230° C., a screw rotation speed of 40 rpm, and a discharge rate of 7 kg/hr, using a screen mesh of a 100 mesh, and using a breaker plate having a cylindrical shape (outer diameter: 55.0 mm, inner diameter: 40.0 mm, length: 20.0 mm), but no resin composition in a pellet form was obtained as the mesh was clogged.

### <Production of Injection Molded Article for Evaluating Number of Coating Films on Surface of Molded Product>

The resin composition obtained in each of Examples 1 to 9 and Comparative Examples 1 to 4 was allowed to dry at 110° C. for two hours, and then injection molded under the following conditions to produce a flat plate-shaped injection molded article having a length of 400 mm, a width of 100 mm, and a thickness of 3.0 mm, with a design surface having an embossed pattern in which the embosses are satin finished and have a depth of 100 μm.
Injection molding machine: SE180D manufactured by Sumitomo Heavy Industries, Ltd. (clamping force of 180 tons, cylinder diameter of 50 mm)
Cylinder temperature: 240° C.
Mold temperature: 80° C.
Injection speed: 200 mm/see
Cooling time: 30 seconds

### <Evaluation of Number of Coating Films on Surface of Molded Product>

An image of the resulting flat plate-shaped molded article was captured with a scanner GT-X900 manufactured by EPSON, and then the number of coating films on the surface of the molded product was measured under the following analysis conditions using image analysis software manufactured by MITANI CORPORATION.
Software: WinROOF2015
Analysis range: 90 mm×269 mm
Image adjustment: Brightness −25, contrast +75, median filter 3*3
Binarization: Automatic binarization, adaptive thresholding method, threshold value of 20 to 255

TABLE 1

| | | Ex. | Ex. | Ex. | Ex. | Ex. | Ex. | Ex. | Ex. | Ex. | C. Ex. | C. Ex. |
|---|---|---|---|---|---|---|---|---|---|---|---|---|
| | | 1 | 2 | 3 | 4 | 5 | 6 | 7 | 8 | 9 | 1 | 2 |
| Component | (A-1) | 25 | 25 | 20 | 30 | 35 | 25 | 25 | 25 | 25 | 50 | 50 |
| (mass %) | Crushed material, content of xylene- | | | | | | | | | | | |
| | insoluble matter: 23.2 mass % | | | | | | | | | | | |
| | (B-1) | 25 | — | — | — | — | — | — | — | — | — | — |
| | Peeled powder of coated film, content of | | | | | | | | | | | |
| | xylene-insoluble matter: 42.8 mass % | | | | | | | | | | | |
| | (B-2) | — | 25 | 30 | 20 | 15 | — | — | — | — | — | — |
| | Peeled powder of coated film, content of | | | | | | | | | | | |
| | xylene-insoluble matter: 41.7 mass % | | | | | | | | | | | |
| | (B-3) | — | — | — | — | — | 25 | — | 25 | 25 | 50 | — |
| | Peeled powder of coated film, content of | | | | | | | | | | | |
| | xylene-insoluble matter: 40.7 mass % | | | | | | | | | | | |
| | (B-4) | — | — | — | — | — | — | 25 | — | — | — | — |
| | Peeled powder of coated film, content of | | | | | | | | | | | |
| | xylene-insoluble matter: 36.5 mass % | | | | | | | | | | | |
| | (C-1) | 40 | 40 | 40 | 40 | 40 | 40 | 40 | 50 | — | — | 50 |
| | Heterophasic propylene polymer material | | | | | | | | | | | |
| | (C-2) | — | — | — | — | — | — | — | — | 50 | — | — |
| | Ethylene-propylene random copolymer | | | | | | | | | | | |
| | (D-1) | 10 | 10 | 10 | 10 | 10 | 10 | 10 | — | — | — | — |
| | Ethylene-1-octene random copolymer | | | | | | | | | | | |

| | | | | | | | | | | | |
|---|---|---|---|---|---|---|---|---|---|---|---|
| No. of coating films (pcs.) | 6958 | 6594 | 7320 | 5898 | 4942 | 5554 | 5126 | 5651 | 7203 | 4638 | 1952 |

| | | C. Ex. | C. Ex. | C. Ex. | C. Ex. |
|---|---|---|---|---|---|
| | | 3 | 4 | 5 | 6 |
| Component | (A-1) | 50 | 100 | — | 100 |
| (mass %) | Crushed material, content of xylene- | | | | |
| | insoluble matter: 23.2 mass % | | | | |
| | (B-1) | — | — | — | — |
| | Peeled powder of coated film, content of | | | | |
| | xylene-insoluble matter: 42.8 mass % | | | | |
| | (B-2) | — | — | — | — |
| | Peeled powder of coated film, content of | | | | |
| | xylene-insoluble matter: 41.7 mass % | | | | |
| | (B-3) | — | — | — | — |
| | Peeled powder of coated film, content of | | | | |
| | xylene-insoluble matter: 40.7 mass % | | | | |
| | (B-4) | — | — | 100 | — |
| | Peeled powder of coated film, content of | | | | |
| | xylene-insoluble matter: 36.5 mass % | | | | |
| | (C-1) | — | — | — | — |
| | Heterophasic propylene polymer material | | | | |
| | (C-2) | 50 | — | — | — |
| | Ethylene-propylene random copolymer | | | | |
| | (D-1) | — | — | — | — |
| | Ethylene-1-octene random copolymer | | | | |

| | | | | |
|---|---|---|---|---|
| No. of coating films (pcs.) | 2013 | 1259 | — | — |

As can be seen from the results of Table 1, the resin composition of each of Examples that satisfy all requirements of the present disclosure enables an injection molded article with a relatively excellent design to be obtained by increasing the number of externally visible coating films while reusing polypropylene. Further, as can be seen from the comparison between Examples 8 and 9 and Comparative Example 1, the configuration that the resin composition further includes the component (C) in addition to the component (A) and the component (B) can increase the number of externally visible coating films.

1. A resin composition comprising:
a component (A): a crushed material of waste car bumpers comprising 1 mass % or more and less than 30 mass % of a xylene-insoluble matter;
a component (B): peeled powder of coated film of waste car bumpers comprising 30 mass % or more and less than 50 mass % of a xylene-insoluble matter; and
a component (C): a propylene-based polymer, wherein
a content of the component (A) is 15 mass % or more and 35 mass % or less, a content of the component (B) is 15 mass % or more and 35 mass % or less, and a content of the component (C) is 30 mass % or more and 70 mass % or less, based on a total mass of the resin composition.

2. The resin composition according to claim 1, further comprising a component (D): an ethylene-α-olefin copolymer, wherein
a content of the component (D) is 5 mass % or more and 15 mass % or less based on the total mass of the resin composition.

3. The resin composition according to claim 1, wherein the component (B) comprises titanium oxide, and
a content of the titanium oxide is 0.05 mass % or more and 5 mass % or less based on a total mass of the component (B).

4. The resin composition according to claim 1, wherein the component (B) comprises aluminum metal, and
a content of the aluminum metal is 0.01 mass % or more and 1 mass % or less based on a total mass of the component (B).

5. The resin composition according to claim 1, wherein the component (B) comprises talc, and
a content of the talc is 5 mass % or more and 20 mass % or less based on a total mass of the component (B).

6. A method for producing a resin composition comprising a step of melt kneading a mixture without allowing the mixture to pass through a screen mesh, the mixture comprising: a component (A): a crushed material of waste car bumpers comprising 1 mass % or more and less than 30 mass % of a xylene-insoluble matter; a component (B): peeled powder of coated film of waste car bumpers comprising 30 mass % or more and less than 50 mass % of a xylene-insoluble matter; and a component (C): a propylene-based polymer, wherein
a content of the component (A) is 15 mass % or more and 35 mass % or less, a content of the component (B) is 15 mass % or more and 35 mass % or less, and a content of the component (C) is 30 mass % or more and 70 mass % or less, based on a total mass of the mixture.

7. An injection molded article comprising the resin composition according to claim 1.
